(19) United States
(12) Patent Application Publication
(10) Pub. No.: US 2005/0117064 A1
(43) Pub. Date: Jun. 2, 2005

(54) Television adjustment system, television, and computer for white balance adjustment

(75) Inventor: Norihiro Higashi, Osaka (JP)

Correspondence Address: Yokoi & Co., U.S.A., Inc., 13700 Marina Pointe Drive #1512, Marina Del Rey, CA, 90292, US

(73) Assignee: Funai Electric Co., Ltd., Osaka (JP)

(21) Appl. No.: 10/971,244

(22) Filed: Oct. 23, 2004

(30) Foreign Application Priority Data
Oct. 30, 2003 (JP) JP2003-272157 U

(51) Int. Cl. H04N 9/73

(52) U.S. Cl. 348/655

(57) ABSTRACT

Disclosed is a television adjustment system wherein component adjustment values (second adjustment values) for adjusting the white balance of an image based on the component video signal (a second video signal) are stored in an EEPROM (a nonvolatile memory). When the component video signal is inputted and an image based on the inputted component video signal is to be displayed, the component video signal is adjusted by amounts dependent on the component adjustment values so that an image which has been subjected to white balance adjustment intended for an image based on the component video signal is displayed. The difference in white balance observed between images based on the composite and the component video signals inputted to a television can be reduced.

### BACKGROUND OF THE INVENTION

1. Field of the Invention

This invention relates to a television adjustment system to perform white balance adjustment for a television selectively inputting plural kinds of video signals which represent brightness and color with plural kinds of signals, a television, and a computer for white balance adjustment.

2. Description of Related Art

Conventionally, a television selectively inputs a composite video signal or a component video signal and displays an image. The composite video signal is a signal combining a luminance signal (Y) and plural color difference signals (such as UV and CbCr). In this specification, the “composite video signal” refers to, in addition to a signal (may be called a video signal) inputted from a composite video input terminal, a signal (may be called an RF signal) inputted from an RF signal input section. A component video signal, on the other hand, is a signal comprising a discrete luminance signal and discrete color difference signals. The television has a chroma circuit configured around a chroma IC. The chroma circuit generates three primary color signals such as RGB signals (R, G and B signals) from the inputted luminance signal and color difference signals. When the generated RGB signals are supplied to a picture tube via a known video output circuit, a corresponding image is displayed.

The chroma IC which has an internal control circuit provided with a memory inputs drive adjustment values and cutoff adjustment values (referred to as white balance adjustment values) for adjusting the white balance of an image based on the composite video signal, stores the inputted adjustment values in the memory, adjusts the drive for each of the color difference signals based on the stored drive adjustment values, and adjusts the cutoff for each of the RGB signals based on the stored cutoff adjustment values. These white balance adjustment values are prepared for each television separately. Each television has an EEPROM and can input the white balance adjustment values and store the inputted white balance adjustment values in the EEPROM. The television, by outputting the white balance adjustment values to the chroma IC, adjusts in the chroma circuit the color difference signals or the RGB signals by amounts dependent on the white balance adjustment values and displays an image which has been subjected to white balance adjustment intended for an image based on the composite video signal.

In a plant where the television is manufactured, white balance adjustment is performed for the television. A television adjustment system used for the white balance adjustment comprises a television, a signal generation circuit, a color analyzer and a computer for white balance adjustment. The signal generation circuit is connected to the composite video input terminal or the RF signal input section of the television. The signal generation circuit generates a reference composite video signal used to determine the white balance adjustment values and outputs the generated reference composite video signal to the television. The color analyzer can detect color component amounts of an image displayed by the television and output the corresponding color component values.

In a state in which the composite video signal is being inputted to the television, the color analyzer detects color component amounts of the image displayed by the television and outputs the corresponding color component values (for example, values corresponding to the xy chromaticity based on the CIE standard). At the TV manufacturing plant, the outputted color component values are visually recognized and the white balance adjustment values to adjust the white balance of the television are manually inputted to the computer for white balance adjustment. The computer is connected to the television and outputs the inputted white balance adjustment values to the television. The television obtains the white balance adjustment values and stores them in the EEPROM under the control of an internal microcomputer.

The white balance adjustment values are for adjusting the white balance of an image based on the composite video signal so that, when the composite video signal is inputted, the television displays an image whose white balance has been adjusted.

The conventional technology as described above pauses problems as follows.

When the component video signal is inputted to the television, the white balance of an image based on the component video signal is adjusted using the white balance adjustment values prepared for adjusting the white balance of an image based on the composite video signal. For this reason, there are cases in which the white balance of an image based on the component video signal is not sufficiently adjusted. Hence, there are also cases in which the difference in white balance observed between an image displayed when the composite video signal is inputted and an image displayed when the component video signal is inputted is conspicuous. It is conceivable to reduce the difference in white balance observed between images based on the two video signals by changing resistance values of resistor circuits connected to signal lines for the component video signal, but changing the resistance values of such resistor circuits is troublesome and takes time.

The technology disclosed in Japanese Patent Laid Open No. Hei 9-130815 is also known, but the technology comprises extracting color saturation data U and V from image data, calculating their average values Ua and Va, and subtracting the average values Ua and Va from the U and V. This technology cannot reduce the difference in white balance observed between images based on the two video signals.

### SUMMARY OF THE INVENTION

The present invention has been made in view of the above problems and it is an aim of the invention to provide a television adjustment system, a television and a computer for white balance adjustment which, when plural kinds of video signals are selectively inputted to the television, can reduce the difference in white balance observed between images based on the video signals.

To achieve the above aim, according to a first aspect of the invention, the television selectively inputs a composite video signal combining a luminance signal and color difference signals or a component video signal comprising a discrete luminance signal and discrete color difference signals, generates three primary color signals from the inputted luminance signal and the inputted color difference signals in an internal chroma circuit, and displays an image based on the generated three primary color signals.

When the reference composite video signal is outputted from the signal generation circuit to the television, the television inputs the reference composite video signal and displays a reference image. The color analyzer then detects color component amounts from the displayed reference image and outputs the corresponding first color component values. When the reference component video signal is outputted from the signal generation circuit to the television, the television inputs the reference component video signal and displays a reference image. The color analyzer then detects color component amounts from the displayed reference image and outputs the corresponding second color component values.

The computer for white balance adjustment, in a state in which the reference composite video signal is being outputted from the signal generation circuit, obtains the first color component values outputted by the color analyzer and determines based on the first color component values white balance adjustment values for the particular television and outputs the determined white balance adjustment values to the television. The television then inputs the white balance adjustment values and stores them in an EEPROM.

The computer for white balance adjustment, in a state in which the reference component video signal is being outputted, obtains the second color component values outputted from the color analyzer. The computer for white balance adjustment then repeats a process of calculating component adjustment values for the particular television based on the second color component values, outputting the calculated component adjustment values to the television and then obtaining the second color component values from the color analyzer until differences between the first and the second color component values obtained are inside a prescribed range. The television inputs the determined component adjustment values and stores them in the EEPROM.

Through the processing as described above, the computer for white balance adjustment matches the white balance of an image based on the component video signal (hereafter also referred to as a component video image) to the white balance of an image based on the composite video signal (hereafter also referred to as a composite video image).

The television outputs the stored white balance adjustment values to the chroma circuit and, in the chroma circuit, adjusts the color difference signals or the three primary color signals or both the color difference signals and the three primary color signals by amounts dependent on the white balance adjustment values. The white balance adjustment values are for adjusting the white balance of a composite video image. Therefore, the television can display an image which has been subjected to white balance adjustment intended for a composite video image. The component adjustment values for adjusting the white balance of a composite video image are also stored in the EEPROM. When the component video signal is inputted, the television outputs the stored component adjustment values to the chroma circuit and, in the chroma circuit, adjusts the color difference signals or the three primary color signals or both the color difference signals and the three primary color signals by amounts dependent on the component adjustment values. The component adjustment values are for adjusting the white balance of a component video image. Therefore, the television can display an image which has been subjected to white balance adjustment intended for a component video image.

As described above, the white balance of not only a composite video image but also a component video image can be sufficiently adjusted to reduce the difference in white balance observed between images based on the composite and the component video signals inputted to the television. Since the white balance adjustment values and the component adjustment values are prepared for each the television separately, the white balances of composite and component video images can be adjusted for each the television separately. Therefore, in each the television to which both the composite and the component video signals are inputted, the difference in white balance observed between a composite video image and a component video image can be reliably reduced. When white balance adjustment is performed, the component adjustment values are automatically set without requiring such troublesome work as adjusting resistance values of resistor circuits in the television to be performed. As a result, the burden of white balance adjustment work at a television manufacturing plant is reduced and productivity at the television manufacturing plant can be increased. An arrangement may be made to allow the computer for white balance adjustment to output—the adjustment values to the television via a buffer amplifier.

The present invention can also be applied to a television which displays an image by selectively inputting plural kinds of video signals which represent brightness and color with plural kinds of signals. Hence, according to a second aspect of the invention, the television adjustment system includes a television which can selectively input a first or a second video signal which represents brightness and color with plural kinds of signals. When displaying an image based on the inputted video signal, the television can display an image which has been subjected to white balance adjustment intended for an image based on the first video signal. The amounts of the white balance adjustment performed are dependent on adjustment values which are stored in a nonvolatile memory for use in adjusting the white balance of an image based on the first video signal. The television adjustment system also includes an adjusting means to adjust the white balance of an image for the television. In the television adjustment system, the television can input second adjustment values for adjusting the white balance of an image based on the second video signal and store the inputted second adjustment values in the nonvolatile memory. When the second video signal is inputted and an image based on the second video signal is to be displayed, the television can display an image which has been subjected to white balance adjustment intended for an image based on the second video signal. The amounts of the white balance adjustment performed are dependent on the second adjustment values stored in the nonvolatile memory. In a state in which a reference signal for the first video signal is being outputted to the television, the adjusting means included in the television adjustment system detects color component amounts of an image displayed by the television and obtains the corresponding first color component values. In a state in which a reference signal for the second video signal is being outputted to the television, the adjusting means detects color component amounts of an image displayed by the television, obtains the corresponding second color component values, determines the second adjustment values based on the first and the second color component values thus obtained so that the white balance of an image based on the second video signal matches the white balance of an image based on the first video signal, outputs the second adjustment values to the television, and thereby effects the white balance adjustment.

The television selectively inputs the first or the second video signal which represents brightness and color with plural kinds of signals, and displays an image based on the inputted video signal. When the reference signal for the first video signal is outputted from the adjusting means to the television, the television inputs the reference signal and displays a reference image. The adjusting means then detects color component amounts from the reference image displayed and obtains the corresponding first color component values. When the reference signal for the second video signal is outputted from the adjusting means to the television, the television inputs the reference signal and displays a reference image. The adjusting means then detects color component amounts from the reference image displayed, obtains the corresponding second color component values, determines the second adjustment values based on the first and the second color component values thus obtained so that the white balance of an image based on the second video signal matches the white balance of an image based on the first video signal, and outputs the second adjustment values to the television. The television then inputs the determined second adjustment values and stores them in the nonvolatile memory.

The television performs adjustment with the amounts of adjustment being dependent on the adjustment values stored in the nonvolatile memory. The adjustment values are for adjusting the white balance of an image based on the first video signal. Therefore, the television can display an image which has been subjected to white balance adjustment intended for an image based on the first video signal.

The second adjustment values for adjusting the white balance of an image based on the second video signal are also stored in the nonvolatile memory. When the second video signal is inputted, the television performs adjustment with the amounts of adjustment being dependent on the second adjustment values stored in the nonvolatile memory. The second adjustment values are for adjusting the white balance of an image based on the second video signal. Therefore, the television can display an image which has been subjected to white balance adjustment intended for an image based on the second video signal.

As described above, the white balance of not only an image based on the first video signal but also an image based on the second video signal can be sufficiently adjusted to reduce the difference in white balance observed between images based on the first and the second video signals inputted to the television. When white balance adjustment is performed, the second adjustment values are automatically set without requiring such troublesome work as adjusting resistance values of resistor circuits in the television to be performed.

The video signals are not limited to the signals inputted from an external device via signal cables. Broadcast signals may also be used. The television is only required to be able to input plural kinds of video signals and display an image. There may be plural kinds of the first video signal or plural kinds of the second video signal.

The television to which the present invention is applied may be a stand-alone device or a device combined with or attached to another device. For example, the television may be one combined with a video deck or a DVD.

The color component values are only required to be corresponding to color component amounts of an image displayed by the television and can be based on various standards. The color component values corresponding to the xy chromaticity based on the CIE (The International Commission on Illumination) standard, for example, will enable accurate white balance adjustment.

Even with the television alone, it is possible to reduce the difference in white balance observed between images based on the first and the second video signals inputted to the television. Hence, according to a third aspect of the invention, the television can selectively input a first or a second video signal which represents brightness and color with plural kinds of signals. When displaying an image based on the inputted video signal, the television can display an image which has been subjected to white balance adjustment intended for an image based on the first video signal with the amounts of the white balance adjustment being dependent on adjustment values which are stored in a nonvolatile memory for use in adjusting the white balance of an image based on the first video signal. Furthermore, the nonvolatile memory also stores second adjustment values for adjusting the white balance of an image based on the second video signal. When the second video signal is inputted and an image based on the second video signal is to be displayed, the television displays an image which has been subjected to white balance adjustment intended for an image based on the second video signal with the amounts of the white balance adjustment being dependent on the second adjustment values stored in the nonvolatile memory.

The plural kinds of signals to represent brightness and color may vary in composition. In a simple composition, they may be comprised of a signal representing brightness and another signal representing color. There are various signals which represent brightness; for example, a luminance signal, a brightness signal and so on. Also, there are various signals which represent color; for example, color difference signals, primary color signals and so on.

In the third aspect that constitutes an example of signal composition utilizing the luminance signal and the color difference signals, as a fourth aspect, one of the first and the second video signals may be a composite signal combining a luminance signal and color difference signals and the other may be a component video signal comprised of a discrete luminance signal and discrete color difference signals. This is an example of signal composition utilizing a concrete and simple combination of video signals.

In the fourth aspect, when the television is to generate three primary color signals from the luminance signal and the color difference signals and display an image based on the three primary color signals, the arrangement of a fifth aspect may be used. That is, the second adjustment values include cutoff adjustment values representing cutoff adjustment amounts at least for the three primary color signals, and the television adjusts each of the three primary color signals by the amounts dependent on the cutoff adjustment values stored in the nonvolatile memory and displays an image which has been subjected to white balance adjustment intended for the second video signal. The cutoff for each of the three primary color signals affects the white balance of an image. Therefore, the white balance of an image based on the second video signal can be adjusted by adjusting cutoffs for a simple signal composition.

In the fifth aspect, the arrangement of a sixth aspect may also be used. That is, the second adjustment values include drive adjustment values representing drive adjustment amounts at least for the color difference signals, and the television adjusts the color difference signals by the amounts dependent on the drive adjustment values stored in the nonvolatile memory and displays an image which has been subjected to white balance adjustment intended for the second video signal. The drive for each of the color difference signals affects the white balance of an image. Therefore, the white balance of an image based on the second video signal can be adjusted by adjusting drives for a simple signal composition.

In the sixth aspect, the nonvolatile memory of a seventh aspect may be a memory which allows data stored therein to be rewritten, and the adjustment values and the second adjustment values may be inputted and stored in the nonvolatile memory. In this arrangement, just writing the adjustment values and the second adjustment values into the nonvolatile memory makes it possible to change the adjustment values and the second adjustment values to be stored in the television so that updating the adjustment values and the second adjustment values is facilitated.

In the seventh aspect, the nonvolatile memory of an eighth aspect may be an EEPROM and the second adjustment values may be prepared for each the television separately and stored in the EEPROM. As the second adjustment values make it possible to adjust the white balance of an image based on the second video signal for each the television separately, the difference in white balance observed between images based on the first and the second video signals inputted to the television can be reduced more.

As a concrete example of the television, in the arrangement of a ninth aspect, the computer for white balance adjustment by itself can also produce an effect of reducing the difference in white balance observed between images based on the first and the second video signals inputted to the television. Hence, the arrangement of a tenth aspect 10 may be used, wherein, applying the present invention to the computer for white balance adjustment alone is also possible. It is also possible to make the computer for white balance adjustment compatible with the system configuration described in claim 1. Furthermore, the computer for white balance adjustment can be configured to make it usable to perform white balance adjustment for the television described in claims 3 to 9.

As described above, according to the first aspect, the white balance of not only an image based on the composite video signal but also an image based on the component video signal can be sufficiently adjusted without involving troublesome work to adjust the television, and the difference in white balance observed between images based on the composite and the component video signals inputted to the television can be reliably reduced.

According to the second and tenth aspects, the white balance of not only an image based on the first video signal but also an image based on the second video signal can be sufficiently adjusted without involving troublesome work to adjust the television, and the difference in white balance observed between images based on plural kinds of video signals inputted to the television can be reduced.

According to the third aspect, the white balance of not only an image based on the first video signal but also an image based on the second video signal can be sufficiently adjusted, and the difference in white balance observed between images based on plural kinds of video signals inputted to the television can be reduced.

According to the fourth aspect, a concrete and simple configuration of the television can be provided.

According to the fifth aspect, it is possible to adjust cutoffs in a simple configuration and reliably adjust the white balance of an image based on the second video signal.

According to the sixth aspect, it is possible to adjust drives in a simple configuration and reliably adjust the white balance of an image based on the second video signal.

According to the seventh aspect, updating the adjustment values and the second adjustment values can be facilitated.

According to the eighth aspect, the nonvolatile memory can be configured in a simple way using a generalized component and the difference in white balance observed between images based on the first and the second video signals can be reduced more.

According to the ninth aspect, the white balance of not only an image based on the composite video signal but also an image based on the component video signal can be sufficiently adjusted, and the difference in white balance observed between images based on the composite and the component video signals inputted to the television can be reduced.

Other and further objects, features and advantages of the invention will appear more fully from the following description.

### BRIEF DESCRIPTION OF THE DRAWINGS

FIG. 1 is a block diagram showing an example of a television adjustment system.

FIG. 2 is a block diagram showing a configuration of a television.

FIG. 3 is a block diagram showing a configuration of a video amplifier/chroma circuit.

FIG. 4 is a circuit diagram showing principal parts of a video output circuit and a picture tube.

FIG. 5 is a diagram showing a circuit for switching between composite mode and component mode.

FIG. 6 is a diagram showing a storage area of an EEPROM in a conventional example.

FIG. 7 is a diagram showing a storage area of an EEPROM of the present embodiment.

FIG. 8 is a diagram showing output voltage pedestal levels of color signals R, G and B.

FIG. 9 is a block diagram showing an approximate configuration of a signal generation circuit.

FIG. 10 is a block diagram showing an approximate configuration of a color analyzer.

FIG. 11 is a block diagram showing a hardware configuration of a computer for white balance adjustment.

FIG. 12 is a flowchart showing a white balance adjustment procedure.

FIG. 13 is a diagram for explaining how various adjustment values are determined.

FIG. 14 is a flowchart showing a processing performed by a TV.

FIG. 15 is a flowchart showing another processing performed by a TV.

### DETAILED DESCRIPTION OF THE PREFERRED EMBODIMENTS

In the following, the preferred embodiment of the present invention will be described in the following order:
(1) Configuration of television adjustment system
(2) Configuration of signal generation circuit
(3) Configuration of color analyzer
(4) Configuration of computer for white balance adjustment
(5) White balance adjustment procedure
(6) Operation of television
   (1) Configuration of Television Adjustment System

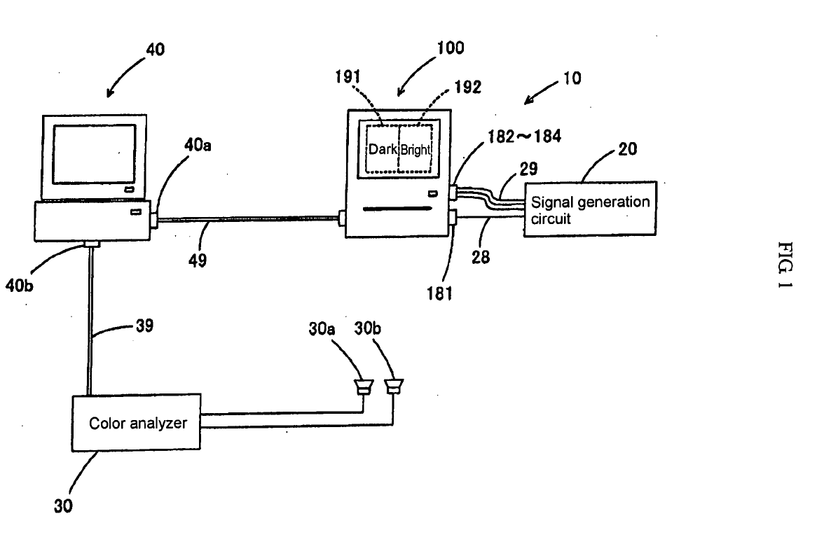

FIG. 1 is a system block diagram showing an approximate configuration of a television adjustment system 10 of the present invention. The system 10 includes a television (hereafter also referred to as “TV”) 100, a signal generation circuit 20, a color analyzer (color analyzing means) 30 and a personal computer for white balance adjustment (hereafter referred to also as “PC”) 40. The TV 100 to be subjected to white balance adjustment is connected to the signal generation circuit 20 via prescribed cables 28 and 29 and also connected to the PC 40 via a prescribed cable 49. The color analyzer 30 connected to the PC 40 via a prescribed serial data cable 39 has a LOW LIGHT adjusting probe 30a and a HIGH LIGHT adjusting probe 30b as sensors for detecting test color patterns displayed on the picture tube screen of the TV 100.

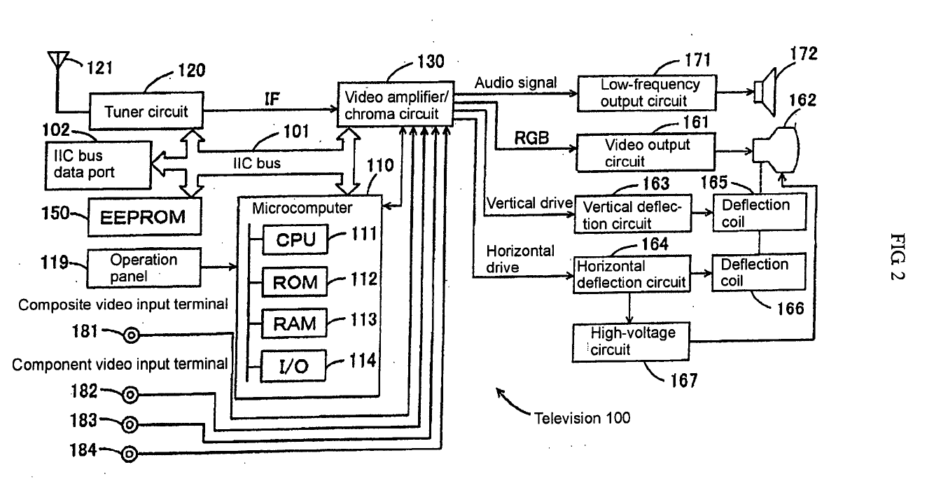

The TV 100 comprises parts represented by reference numbers 101, 102, 110, 119, 120, 121, 130, 150, 161 to 167, 171, 172, and 181 to 184 in FIG. 2. Connected to the IIC bus 101 are the microcomputer 110, the tuner circuit 120 configured around a known tuner IC, the video amplifier/chroma circuit 130 configured around a chroma IC, the EEPROM (Electrically Erasable Programmable Read-Only Memory) 150 and the IIC bus data port 102. These circuits mutually send and receive serial data via the IIC bus 101. The tuner circuit 120 and the video amplifier/chroma circuit 130 are directly connected to the microcomputer 110 with separate signal lines and operate based on control signals received from the microcomputer 110 via the signal lines.

An operation panel 119 and a remote control light receiving section, not shown, are directly connected to the microcomputer 110. When a data input operation is performed at the operation panel 119, the microcomputer 110 can receive the corresponding data from the operation panel 119. The microcomputer 110 includes a CPU 111, ROM 112, RAM 113, plural I/O ports 114 and a timer circuit (not shown) which are connected to an internal bus. The CPU 111 controls the overall operation of the TV 100 in accordance with internal circuit control programs written in the ROM 112 and the EEPROM 150, thereby materializing functions of the TV.

To the video amplifier/chroma circuit 130, one of the following three signals is input: an intermediate frequency signal (IF) from the tuner circuit 120, a composite video signal (video signal combining a luminance signal and color difference signals) from a composite video input terminal 181, and a component video signal (a video signal, called a YUV signal, comprised of a discrete luminance signal and discrete color difference signals) from three component video input terminals 182 to 184. Both video signals represent brightness and color with plural kinds of signals. In the following description of the present embodiment, the composite video signal will be referred to as the first video signal and the component video signal will be referred to as the second video signal, respectively. The TV can display an image by inputting a component video signal comprising a luminance signal Y, a blue color difference signal U and a red color difference signal V. The TV may also be one which displays an image by inputting a component signal comprising a luminance signal Y, a blue color difference signal Cb and a red color difference signal Cr. The video amplifier/chroma circuit 130 outputs RGB signals (three primary color signals consisting of R (red), G (green) and B (blue)) to the video output circuit 161, a vertical drive signal to the vertical deflection circuit 163, a horizontal drive signal to the horizontal deflection circuit 164 and an audio signal to the low-frequency output circuit 171 configured around a known audio amplifier IC. The picture tube (CRT) 162 comprising the deflection coils 165 and 166 is connected to the video output circuit 161. The vertical deflection coil 165 is connected to the vertical defection circuit 163. The high-voltage circuit 167 configured around the horizontal deflection coil 166 and a known flyback transformer (FBT) is connected to the horizontal deflection circuit 164. The picture tube 162 is also connected to the high-voltage circuit 167. The speaker 172 is connected to the low-frequency output circuit 171.

The tuner circuit 120 is a known circuit which can generate an intermediate frequency signal from a TV (television) signal of a prescribed television standard inputted from the antenna 121 and then output the generated intermediate frequency signal. Among the prescribed television standards are PAL, SECAM and NTSC. The tuner circuit 120 may be capable of receiving TV signals of plural television standards and generating an intermediate frequency signal. The tuner circuit 120 incorporates a frequency synthesizer and comprises a high-frequency amplifier circuit, a local oscillator circuit and a mixer circuit (which are not shown). A tuner circuit of a voltage synthesizer type is also usable.

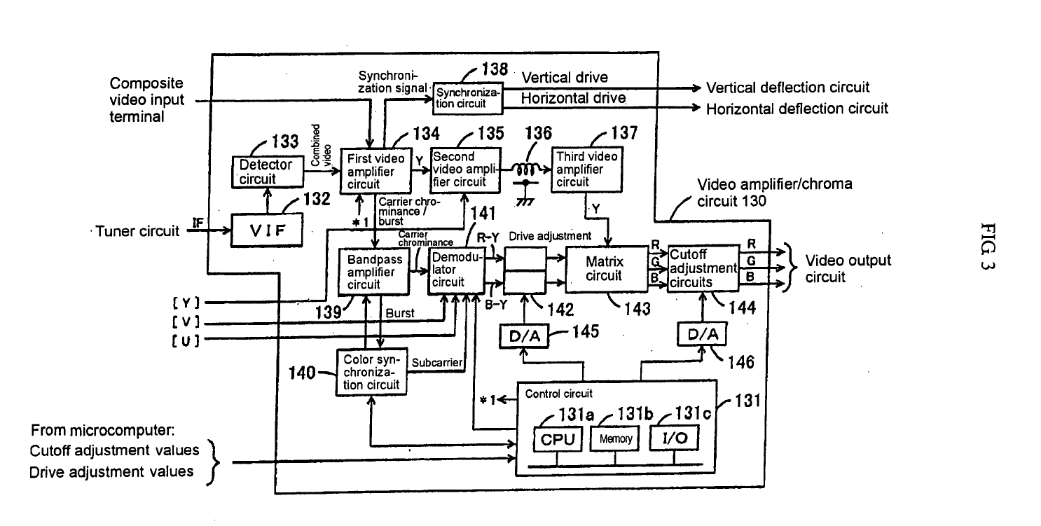

The video amplifier/chroma circuit 130 comprises parts represented by reference numbers 131 to 146 in FIG. 3. In the present example, the parts 134 to 137 make up video amplifier circuits and the parts 139 to 146 make up a chroma circuit. The video amplifier/chroma circuit 130 is a single-chip IC called a chroma IC attached with such external parts as resistor circuits and capacitors.

The control circuit 131 is a microcomputer comprising a CPU 131a, a memory 131b and plural I/O ports 131c which are connected to an internal bus. The CPU 131a controls the whole of the video amplifier/chroma circuit 130 in accordance with an internal circuit control program written in the memory 131b. It is possible to input cutoff/drive adjustment values (cutoff adjustment values and drive adjustment values) to the memory 131b from the external microcomputer 110 via the IIC bus 101 to store the input values in the memory 131b.

The intermediate frequency amplifier circuit (VIF) 132 is a known circuit which inputs an intermediate frequency signal from the tuner circuit 120, processes the inputted intermediate frequency signal for intermediate frequency amplification, and outputs the amplified intermediate frequency signal to the detector circuit 133. The detector circuit 133 is a known circuit which, when the intermediate frequency signal having undergone intermediate frequency amplification is received, processes the received intermediate frequency signal for video detection while receiving an oscillation signal from a VCO (Voltage Controlled Oscillator), not shown, thereby generating a combined video signal and then outputs the generated combined video signal to the first video amplifier circuit 134. As for audio, the audio component of the intermediate frequency signal having undergone intermediate frequency amplification is mixed with an oscillation signal to generate a second audio intermediate frequency signal of, for example, 4.5 MHz. The second audio intermediate frequency signal is inputted to an FM detection circuit, not shown, in which FM detection is performed to generate an audio signal. The generated audio signal is outputted to the external low-frequency output circuit 171.

The first video amplifier circuit 134 separates the combined video signal inputted from the detector circuit 133 into a luminance signal (Y), a carrier chrominance/burst signal and a synchronization signal, and outputs the separated signals to the second video amplifier circuit 135, the bandpass amplifier circuit 139 and the synchronization circuit 138, respectively. The carrier chrominance/burst signal is a signal combining a carrier chrominance signal and a burst signal (also called a color burst signal). The first video amplifier circuit 134 can also input the composite video signal, separate the composite video signal into a luminance signal, a carrier chrominance/burst signal and a synchronization signal, and output the separated signals to the second video amplifier circuit 135, the bandpass amplifier circuit 139 and the synchronization circuit 138, respectively.

The separated luminance signal is amplified while going through the second video amplifier circuit 135, the delay circuit 136 and the third video amplifier circuit 137, and then inputted to the matrix circuit 143. The second video amplifier circuit 135 can also input the luminance signal [Y] included in the component video signal, amplifies the luminance signal, and output the amplified luminance signal to the delay circuit 136. The synchronization circuit 138 is a known circuit which generates a sawtooth shaped vertical drive signal and a sawtooth shaped horizontal drive signal from the synchronization signal inputted to it and outputs the generated signals to the external vertical deflection circuit 163 and the external horizontal deflection circuit 164.

The bandpass amplifier circuit 139 is a known circuit which separates the carrier chrominance/burst signal inputted to it into a carrier chrominance signal and a burst signal and outputs the separated signals to the demodulator circuit 141 and the color synchronization circuit 140, respectively. The color synchronization circuit 140 is a known circuit which restores a subcarrier from the burst signal inputted to it and outputs the restored subcarrier to the demodulator circuit 141. The demodulator circuit 141 takes out two color difference signals R-Y and B-Y from the carrier chrominance signal inputted to it using the subcarrier also inputted to it as a reference and outputs the two color difference signals to the drive adjustment circuits 142. The demodulator circuit 141 can also input two color difference signals [V] and [U] included in the component video signal and output the two signals as color difference signals R-Y and B-Y to the drive adjustment circuits 142.

The drive adjustment circuits 142 are each configured around, for example, a gain control amplifier. One each of the drive adjustment circuits 142 is provided for each of the two input color difference signals R-Y and B-Y. One each of the D/A conversion circuits 145 (unified in FIG. 3) is connected to each of the drive adjustment circuits 142. The D/A conversion circuits 145 are connected to the control circuit 131. The drive adjustment circuits 142 adjust the drives for the color difference signals R-Y and B-Y, respectively, according to the output voltages of the D/A conversion circuits 145, and output the color difference signals to the matrix circuit 143.

The matrix circuit 143 generates three primary color signals R, G and B by combining the luminance signal Y and color difference signals R-Y and B-Y inputted to it and outputs the generated three primary color signals to the cutoff adjustment circuits 144 (unified in FIG. 3). When displaying an image based on a TV signal of the PAL or the SECAM standard, a standardized YUV signal is inputted to the matrix circuit 143 and the YUV signal is converted into color signals R, G and B, for example, using the following conversion equations:
R=Y+1.140V
G=Y−0.396U−0.581V
B=Y+2.029U
where the Y component (luminance) complies with the CIE 1931 XYZ color coordinate system.

When displaying an image based on a TV signal of the NTSC standard, a matrix circuit capable of converting standardized YCbCr signals into color signals R, G and B may be used.

The cutoff adjustment circuits 144 are each configured around, for example, a clamp circuit which applies a positive or negative DC voltage to a signal. One each of the cutoff adjustment circuits 144 is provided for each of the color signals R, G and B inputted to the circuits. One each of the D/A conversion circuits 146 (unified in FIG. 3) is connected to each of the cutoff adjustment circuits 144. The D/A conversion circuits 146 are connected to the control circuit 131. The cutoff adjustment circuits 144 adjust the cutoffs for the color signals R, G and B, respectively, according to the output voltages of the corresponding D/A conversion circuits 146 and output the adjusted color signals to the external video output circuit 161. More concretely, the cutoff adjustment circuits 144 each apply a DC voltage approximately proportional to the voltage outputted from the corresponding one of the D/A conversion circuits 146 to the corresponding color signal R, G, or B.

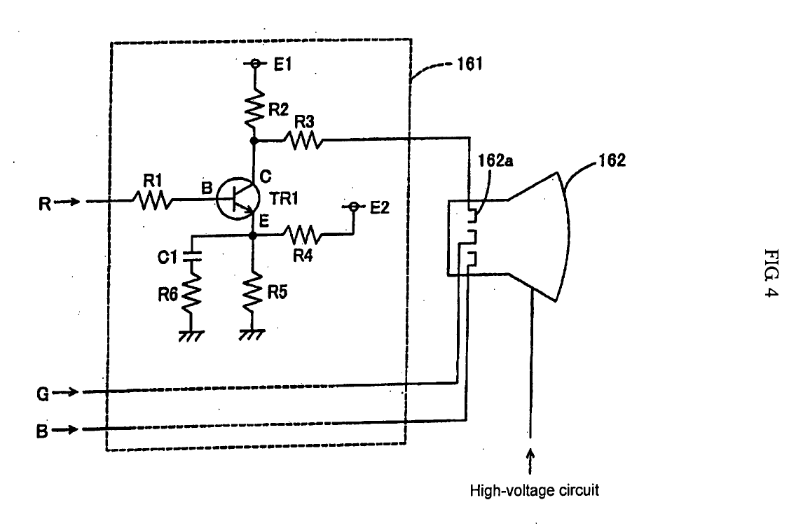

FIG. 4 is a circuit diagram showing principal parts of the video output circuit 161 and the picture tube 162. For the video output circuit 161, only a portion to process the color signal R, that is, the portion to amplify the color signal R and supply the amplified color signal R to a—cathode 162a of the picture tube 162 is shown in FIG. 4. The portions to amplify the color signals G and B and supply the amplified color signals G and B to the cathode 162a of the picture tube 162 are not shown in FIG. 4, since the same configuration as for the portion to process the color signal R can be used for the portions to process the color signals G and B. The portion to process the color signal R includes an npn transistor TR1, resistor elements R1 to R6, and a capacitor C1. The collector of the transistor TR1 is connected to one end of each of the resistor elements R2 and R3. The other end of the resistor element R2 is connected to, for example, a power line of voltage E1, for example, 100 to 200 V, and the other end of the resistor element R3 is connected to the cathode 162a. The emitter of the transistor TR1 is connected to one end of each of the capacitor C1, the resistor element R4 and the resistor element R5. The other end of the capacitor C1 is connected to one end of the resistor element R6. The other end of the resistor R6 is connected to ground. The other end of the resistor element R4 is connected to a power line of voltage E2, for example, 7 to 14 V. The other end of the resistor element R5 is connected to ground.

The color signal R inputted to the base of the transistor TR1 via the resistor element R1 is amplified by the transistor TR1 and then outputted to the cathode 162a via the resistor element R3. In the same manner, each of the color signals G and B is also amplified by an npn transistor and then outputted to the corresponding cathode assigned to the color signal of the picture tube 162.

With reference to FIG. 2, the deflection circuits 163 and 164 generate vertical and horizontal drive currents corresponding to input vertical and horizontal drive signals, respectively, and supply the generated drive currents to the deflection coils 165 and 166, respectively. The deflection coils 165 and 166 generate magnetic fields in the picture tube 162, thereby driving thermal electrons heading for the screen of the picture tube 162 vertically and horizontally, respectively. The horizontal deflection circuit 164 generates a high-frequency signal and outputs it to the high-voltage circuit 167. The high-voltage circuit 167 generates a high voltage using the high-frequency signal inputted to it and supplies the generated high voltage to the anode of the picture tube 162. As a result, in the picture tube 162, electron beams corresponding to the amplified color signals R, G and B are emitted while being driven thereby causing an image to appear on the screen of the picture tube 162.

The audio signal is inputted to the low-frequency output circuit 171 to be amplified there and the amplified audio signal is then inputted to the speaker 172 causing the corresponding sound to be heard from the speaker 172.

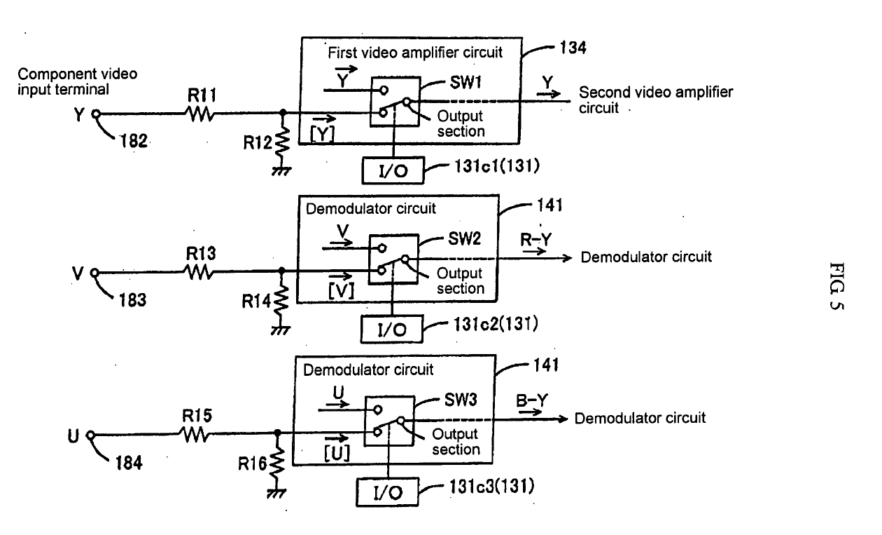

FIG. 5 shows a circuit for switching between composite mode in which a composite video signal is inputted to display an image and component mode in which a component video signal is inputted to display an image. The first video amplifier circuit 134 includes a switching circuit SW1 and the demodulator circuit 141 includes two switching circuits SW2 and SW3. The switching circuits SW1 to SW3 are connected to I/O ports 131c1 to 131c3 (131c) included in the control circuit 131, respectively. Each of the switching circuits SW1 to SW3 has two inputs (shown on the left of the switching circuit) and one output (shown on the right of the switching circuit) and is made up of an IC which switches between the two inputs depending on the level of input voltage. When the level of voltage inputted to any of the switching circuits SW1 to SW3 is high (hereafter referred to as H), the switching circuit inputs a separated video signal, that is, in FIG. 1, the upper one of a pair of inputs to the switching circuit and outputs the separated video signal via the output section (composite-mode operation). When the level of voltage inputted to any of the switching circuits SW1 to SW3 is low (hereafter referred to as L), the switching circuit inputs a component video signal, that is, in FIG. 1, the lower one of a pair of inputs to the switching circuit and outputs the component video signal via the output section (component-mode operation).

Resistor elements R11, R13 and R15 are connected between component video input terminals 182 to 184 and the switching circuits SW1 to SW3, respectively. Resistor elements R12, R14 and R16 are connected between the ends connected to the corresponding switching circuits SW1 to SW3 of the resistor elements R11, R13 and R15 and ground. Therefore, of an input luminance signal which passes the resistor element R11 and then enters the input section of the switching circuit SW1 (this luminance signal is indicated as [Y]) and another input luminance signal (Y) derived from the composite video signal, one is selected and finally outputted to the second video amplifier circuit 135.

Input color difference signals V and U pass resistor elements R13 and R15 and then enter the input sections of the switching circuits SW2 and SW3, respectively (these color difference signals are indicated as [V] and [U], respectively). Of the color difference signal [V] and a color difference signal (V) derived from the composite video signal, one is selected and finally outputted to the demodulator circuit 141 as a color difference signal R-Y. Similarly, one of the color difference signal [U] and a color difference signal (U) derived from the composite video signal is selected and finally outputted to the demodulator circuit 141 as a color difference signal B-Y.

The control circuit 131 inputs the cutoff/drive adjustment values stored in the EEPROM 150 from the external microcomputer 110 and holds the values. The cutoff/drive adjustment values are digital values which represent 256 gradations, that is, 0 to 255, for example, in eight bits each. The control circuit 131 outputs the digital drive adjustment values to the D/A conversion circuit 145 and the digital cutoff adjustment values to the D/A conversion circuit 146 thereby causing drive adjusting analog voltages to be outputted to the drive adjustment circuit 142 and cutoff adjusting analog voltages to be outputted to the cutoff adjustment circuit 144. Thus, in accordance with instructions given by the microcomputer 110, the control circuit 131 can perform adjustments, the amounts of which are dependent on the cutoff and drive adjustment values, thereby effecting white balance adjustment for the image.

As described above, the TV selectively inputting a composite video signal and a component video signal generates, in an internal chroma circuit, three primary color signals R, G and B from a luminance signal Y and color difference signals V and U, and then displays an image based on the generated color signals R, G and B. During the above process, in the chroma circuit, color difference signals R-Y and B-Y and color signals R, G and B are subjected to cutoff and drive adjustments, the amounts of which are dependent on the cutoff and drive adjustment values stored in an EEPROM.

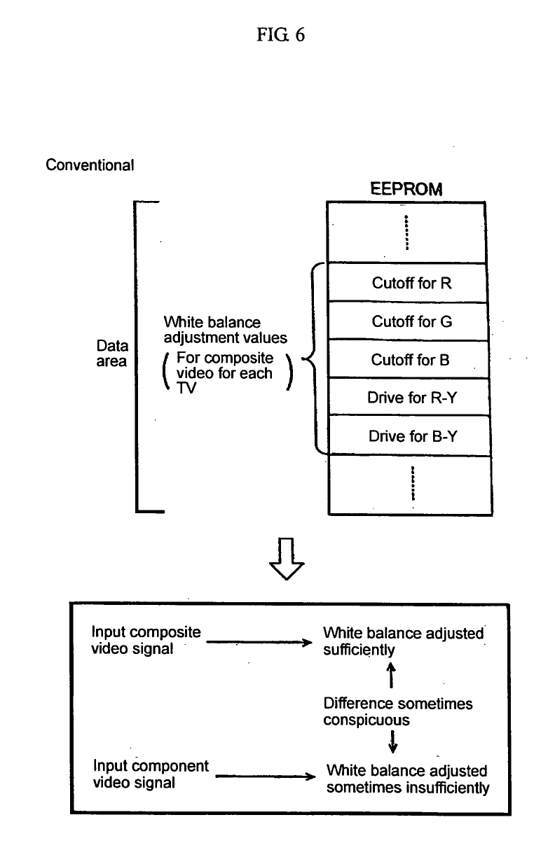

Conventionally, as shown in FIG. 6, only five kinds of white balance adjustment values which enable white balance adjustment for a composite video image (an image based on a composite video signal) are stored in an EEPROM. More concretely, five types of adjustment values, that is, a cutoff adjustment value for a color signal R, a cutoff adjustment value for a color signal G, a cutoff adjustment value for a color signal B, a drive adjustment value for a color difference signal R-Y and a drive adjustment value for a color difference signal B-Y are set for each TV and they are written in a prescribed data area of an EEPROM.

The above white balance adjustment values are for adjusting the white balance of a composite video image. Therefore, when white balance adjustment is performed using the above white balance adjustment values, an image having undergone white balance adjustment intended for a composite video image is displayed. Even when a component video signal is inputted to a TV, the input component video signal is subjected to the white balance adjustment intended for a composite video image. In this way, there have been cases in which the white balance has not been sufficiently adjusted for a component video image (an image based on a component video signal). Hence, there have been cases in which a difference in white balance observed between when a composite video signal is inputted and when a component video signal is inputted has been conspicuous.

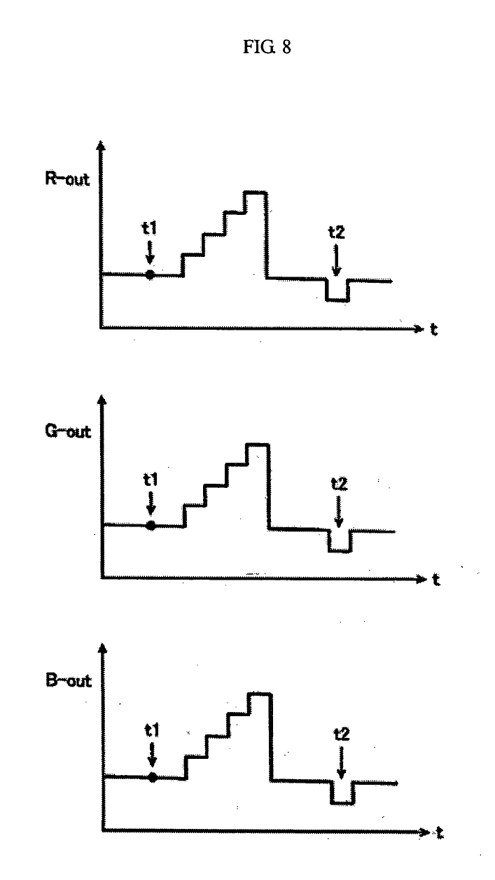

It is conceivable to adjust the voltages of the component video signal components [Y], [V] and [U] by changing the resistance values of the resistor elements R12, R14 and R16 shown in FIG. 5 so as to adapt the component video signal to the white balance adjustment intended for a composite video image. By changing the resistance values, it is possible as shown in FIG. 8 to adjust the pedestal level of the output voltage of each of the color signals R, G and B (indicated as R-out, G-out and B-out, respectively) upward or downward. In FIG. 8, the vertical axis of each graph represents the output voltage of the corresponding color signal R, G or B, and the horizontal axis represents time t. The pedestal level is the output voltage of the black level (at time t1). The pedestal level is the lowest voltage level excluding the output voltage (at time t2) of the synchronization signal. However, even if the resistor elements R12, R14 and R16 are changed into variable resistors, adjusting the resistance values to adapt a component video signal to white balance adjustment intended for a composite video image will be troublesome while taking too much time.

It is also conceivable to use a chroma IC which includes a pedestal level setting circuit. In this case, too, changing the settings of such a circuit to adapt a component video signal to white balance adjustment intended for a composite video image will be troublesome and take too much time.

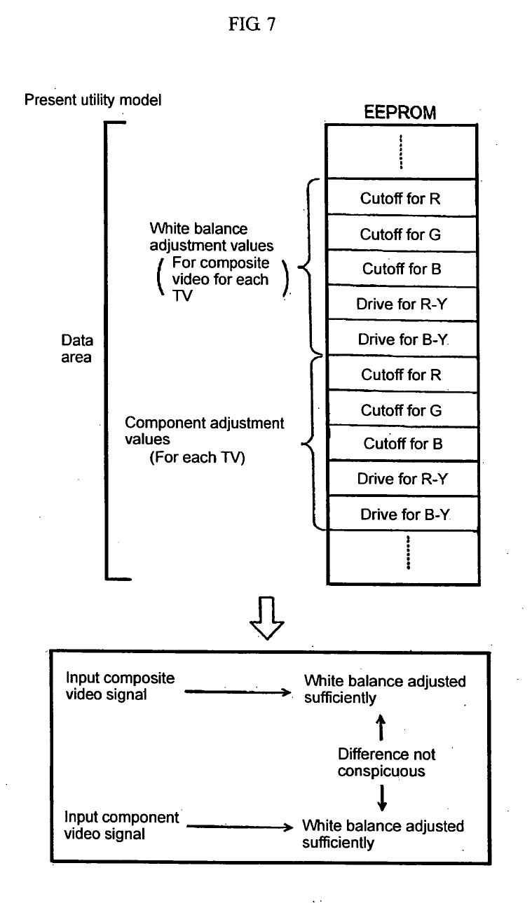

In the present invention, as shown in FIG. 7, in addition to the five kinds of white balance adjustment values (the adjustment values meant in the present invention), another five kinds of component adjustment values (referred to as the second adjustment values in the present invention) which enable white balance adjustment for component video are also stored in the EEPROM 150. The component adjustment values also comprise a cutoff adjustment value for a color signal R, a cutoff adjustment value for a color signal G, a cutoff adjustment value for a color signal B, a drive adjustment value for a color difference signal R-Y and a drive adjustment value for a color difference signal B-Y. These five values are set for each TV and are written in a prescribed data area of an EEPROM. The component adjustment values and the above white balance adjustment values are inputted via the IIC bus data port 102 connected to the IIC bus 101 and stored in the EEPROM 150 under the control of the microcomputer 110. These adjustment values are set for each TV separately so that they slightly differ between TVs.

Using the arrangements as described above, the TV can input the component adjustment values that enable white balance adjustment for a component video image and store them in the EEPROM in addition to the white balance adjustment values used to adjust the white balance of a composite video image. When a component video signal is inputted, the component adjustment values stored in the EEPROM are outputted to the chroma circuit. In the chroma circuit, the combination of the color difference signals R-Y and B-Y and the color signals R, G and B is subjected to adjustment processing, the amount of which is dependent on the component adjustment values stored in the EEPROM. In this arrangement, when a component video signal is inputted, the picture tube 162 can show an image which has been subjected to white balance adjustment intended for the component video signal.

The TV to which the present invention is applied may be an apparatus which subjects only the color difference signals or only the three primary color signals to adjustment processing, the amount of which is dependent on the component adjustment values. The present invention can also be applied to a TV which performs cutoff adjustment only or drive adjustment only.

(2) Configuration of Signal Generation Circuit

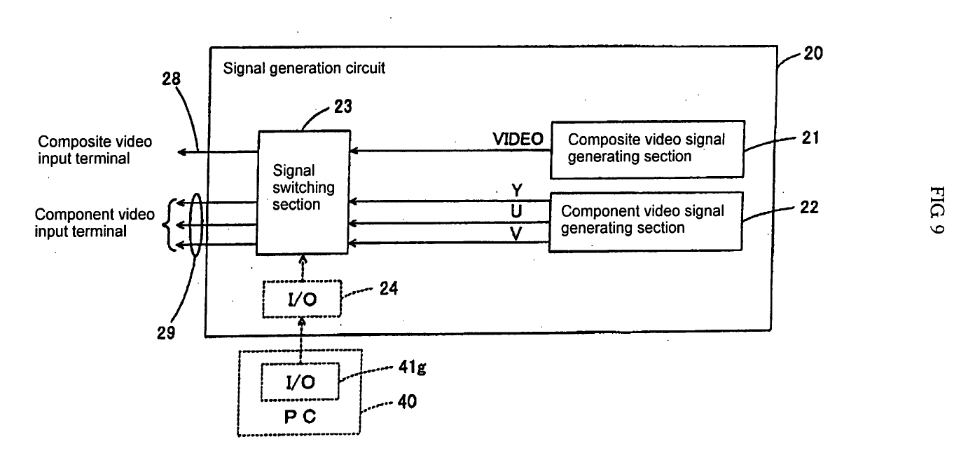

The signal generation circuit 20 to be connected to the TV 100 includes, as shown in FIG. 9, signal generating sections 21 and 22 and a signal switching section 23 connected to the signal generating sections 21 and 22. The signal switching section 23 is connected to the composite video input terminal 181 of the TV via the cable 28 for composite video signal and also connected to the component video input terminals 182 to 184 of the TV via the cables 29 for component video signal.

The composite video signal generating section 21 generates a reference composite video signal (reference signal for the first video signal). The component video signal generating section 22 generates a reference component video signal composed of Y, U and V components (reference signal for the second video signal). Each of the reference signals makes the left half of the display screen of the TV 100 uniformly dark with a prescribed luminance (for example, 1 fL (foot-lamberts)) and the right half of the screen of the TV 100 uniformly bright with another prescribed luminance (for example, 50 fL). The signal switching section 23 switches between the reference composite video signal and the reference component video signal to input either one of the two reference signals. When the reference composite video signal is inputted, it is outputted to the composite video input terminal 181 of the TV 100. When the reference component video signal is inputted, it is outputted to the component video input terminals 182 to 184 of the TV 100.

Thus, the signal generation circuit 20 can generate a reference composite video signal used to determine the white balance adjustment values and a reference component video signal used to determine the component adjustment values, and selectively output one of the reference signals to the TV 100.

When one of the above reference signals is inputted, the TV 100 shows a uniformly dark screen 191 on the left half of its display screen and a uniformly bright screen 192 on the right half of its display screen as shown in FIG. 1. White balance adjustment for the type of input video signal is performed by measuring the color components of the image on both the left and the right halves of the display screen.

Various configurations are conceivable for the signal generation circuit. Conventional signal generation circuits used for various types of TV adjustment work may also be used. An I/O port 24 may be connected to the signal switching section 23. Connecting the I/O port 24 to an I/O port 41g of the PC 40 makes it possible to control from the PC 40 the switching between the reference composite video signal and the reference component video signal.

(3) Configuration of Color Analyzer

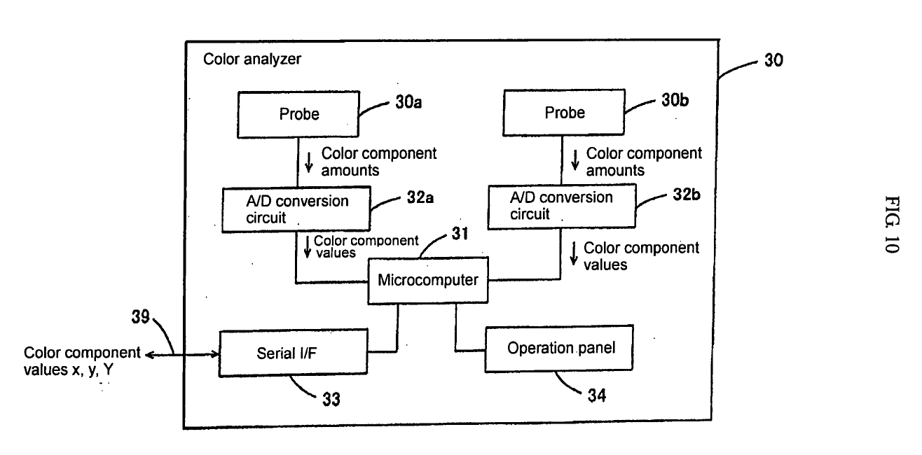

The color analyzer 30 comprises, as shown in FIG. 10, a microcomputer 31, A/D conversion circuits 32a and 32b, a serial I/F (such as a USB I/F or an RS-232C IF) 33 and an operation panel 34 in addition to the probes 30a and 30b. The A/D conversion circuits 32a and 32b, the I/F 33 and the operation panel 34 are connected to the microcomputer 31. The probes 30a and 30b are connected to the A/D conversion circuits 32a and 32b, respectively. The serial I/F 33 is connected to a COM port 40b of the PC 40 via a serial data cable (such as a USB cable or an RS-232C cable) 39.

The probes 30a and 30b each have a light-sensitive element, for example, made of a silicon photocell. When the light receiving surface of one of the probes 30a and 30b is brought into contact with the display screen of the TV 100, the probe can convert color component amounts of the image being displayed into voltage signals thereby making it possible to measure the color component amounts. The probes can detect color component amounts corresponding to the xy chromaticity based on the CIE standard and also color component amounts corresponding to the luminance Y. In the present embodiment, the LOW LIGHT adjusting probe 30a is applied to the dark screen 191 on the left half of the display screen and the HIGH LIGHT adjusting probe 30b is applied to the bright screen 192 on the right half of the display screen. In this way, the LOW LIGHT adjusting probe 30a detects the xy chromaticity and luminance Y on the dark screen 191 of the TV 100 and the HIGH LIGHT adjusting probe 30b detects the xy chromaticity and luminance Y on the bright screen 192 of the TV 100.

The A/D conversion circuits 32a and 32b convert the color component amounts detected as analog amounts by the LOW LIGHT adjusting probe 30a and the HIGH LIGHT adjusting probe 30b into digital color component values, respectively, thereby enabling the microcomputer 31 to obtain the values corresponding to the xy chromaticity and the luminance Y.

The microcomputer 31 accepts both manual inputs from the operation panel 34 and inputs from the PC 40 via the serial I/F 33, and controls the whole of the color analyzer 30 according to the content of inputs. When color component values are received from the A/D conversion circuits 32a and 32b, the microcomputer 31 outputs the received color component values to the COM port 40b via the cable 39.

Thus, the color analyzer 30 can detect the color component amounts of an image displayed on the TV 100 and output the corresponding color component values.

Various configurations are conceivable for the color analyzer 30. Conventional color analyzers used for various types of TV adjustment work may also be used.

(4) Configuration of Computer for White Balance Adjustment

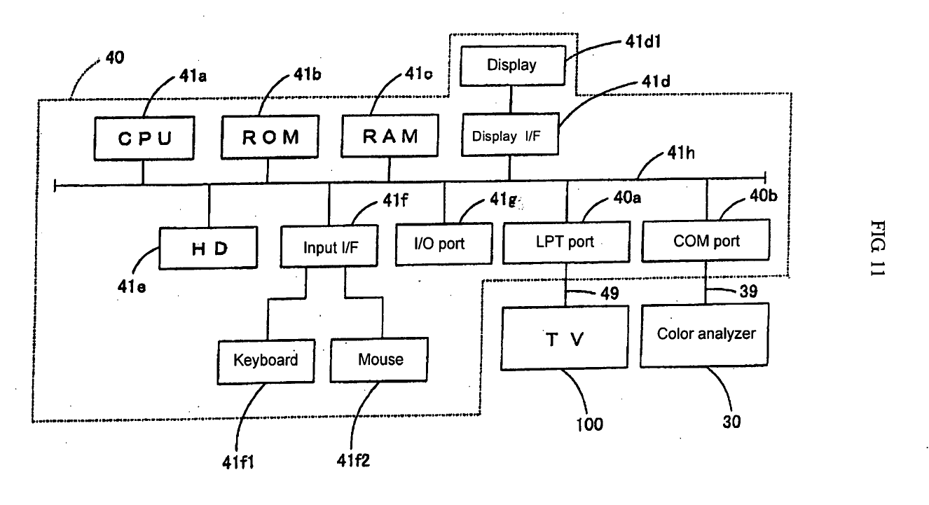

In the PC 40, as shown in FIG. 11, a CPU 41a, a ROM 41b, a RAM 41c, a display I/F 41d, a hard disk with driver function 41e, an input I/F 41f, an I/O port 41g, an LPT port 40a and a COM port 40b are connected to a bus 41h. A display 41dl is connected to the display I/F 41d. A keyboard 41f1 and a mouse 41f2 are connected to the input I/F 41f. The TV 100 is connected to the LPT port 40a via the cable 49. The color analyzer 30 is connected to the COM port 40b via the cable 39.

A prescribed control program is written in the ROM 41b. The CPU 41a executes the control program using the RAM 41c as a work area. An application program for white balance adjustment is stored in the hard disk 41e. As required, the application program is read out to the RAM 41c to be executed. The PC 40 performs white balance adjustment for the image to be displayed by outputting various adjustment values to the TV 100 The PC 40 may be a personal computer such as a desktop computer, a notebook computer or a mobile computer. It may also be a computer other than personal computers. In the television adjustment system 10, various adjustment values are automatically determined and outputted to the TV so that the burden of white balance adjustment at a TV manufacturing plant is reduced.

(5) White Balance Adjustment Procedure

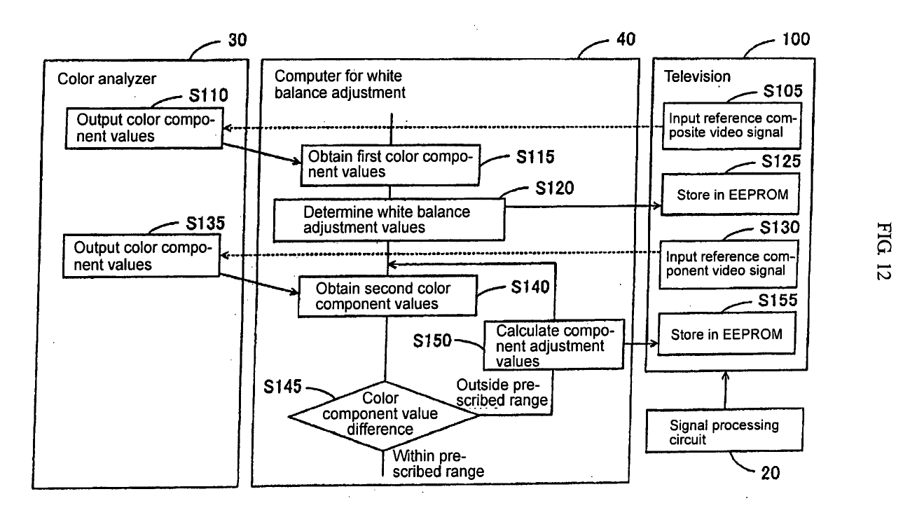

FIG. 12 is a flowchart showing a white balance adjustment procedure. It is premised that the white balance of the TV 100 is adjusted in the final adjustment process at the TV manufacturing plant with the TV 100 incorporating an EEPROM storing the default white balance adjustment values and the default component adjustment values.

First, the signal switching section 23 is manually set to the composite side causing the reference composite video signal to be outputted from the signal generation circuit. In this state, the TV 100 inputs the reference composite video signal via the composite video input terminal 181 (step S105: the “step” will hereafter be omitted). As an alternative method, a signal to set the signal switching section 23 to the composite side may be outputted from the PC 40 to the signal switching section 23 via the I/O port 41g. The TV 100 adjusts the color difference signals R-Y and B-Y and the color signals R, G and B by the amounts dependent on the default white balance adjustment values, and displays a white balance adjustment image as shown in FIG. 1 on the display screen.

Next, the LOW LIGHT adjusting probe 30a and the HIGH LIGHT adjusting probe 30b are manually brought into contact with the display screen of the TV 100. In this state, the color analyzer 30 detects the color component amounts on both the dark screen 191 and the bright screen 192, and outputs the color component values corresponding to the detected color component amounts to the PC 40 (S110). The color component values may comprise, for example, values corresponding to the xy chromaticity and luminance values.

The PC 40 determines whether the reference composite video signal is outputted from the signal generation circuit 40. When the PC 40 determines that the reference composite video signal is outputted from the signal generation circuit 40, the PC 40 obtains the first color component values (S115) outputted from the color analyzer 30 separately for the dark screen 191 and for the bright screen 192. In the present embodiment, when a prescribed key operation is performed from the keyboard 41f1, the PC 40 determines that the reference composite video signal is being outputted. Until the prescribed key operation is performed, the processing of S115 is not performed. Based on the first color component values obtained from the color analyzer 30, the PC 40 determines five kinds of white balance adjustment values and outputs the determined values to the TV 100 (S120). The TV 100 inputs the five kinds of white balance adjustment values via the IIC bus data port 102 and, as shown in FIG. 7, stores the values in the EEPROM 150 under the control of the microcomputer 110 (S125). When a composite video signal is inputted, the TV 100 reads out the white balance adjustment values from the EEPROM, adjusts, in the internal chroma circuit, the color difference signals R-Y and B-Y and the color signals R, G and B by the amounts dependent on the white balance adjustment values, and displays an image on the display screen.

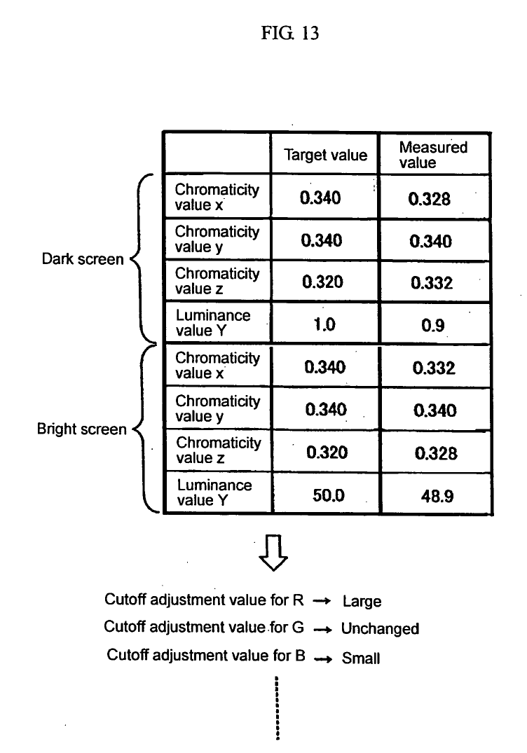

For example, with the target chromaticity value x (red component) set to 0.340 (CIE chromaticity x, for example) as shown in FIG. 13, when the measured chromaticity value x is smaller than the target value, the PC 40 that has obtained the measured value sets a cutoff adjustment value to increase the chromaticity value x. Conversely, when the measured value is greater than the target value as in the case of chromaticity value z (blue component) as shown in FIG. 13, the PC 40 that has obtained the measured value sets a cutoff adjustment value to decrease the chromaticity value z. The chromaticity value z can be calculated using the equation: z=1−x−y. Various equations can be used to determine the cutoff adjustment value. The following equation, for example, can determine the cutoff adjustment value:
C=Cm+C0×{x0−(x1+x2)/2} (1)
where
x0=target color component value,
x1=color component value measured on the dark screen,
x2=color component value measured on the bright screen,
C0=conversion factor for converting a cutoff adjustment value variation into a color component value variation (C0>0), and
Cm=median cutoff adjustment value (Cm>0).

Take another example. With the target luminance value Y set to 1.0 (in fL, for example) for the dark screen 191 and 50.0 for the bright screen 192, when a measured value is smaller than the corresponding target value, the PC 40 that has obtained the measured value sets a drive adjustment value to increase the luminance value Y. Conversely, when a measured value is greater than the corresponding target value, the PC 40 that has obtained the measured value sets a drive adjustment value to decrease the luminance value Y. To give an example, the following equation can determine the drive adjustment value D:
D=Dm+D1×x0−D0×(Y02−Y01)/(Y12−Y11) (2)
where
Y01=target luminance value (for the dark screen),
Y02=target luminance value (for the bright screen),
Y11=luminance value measured on the dark screen,
Y12=luminance value measured on the bright screen,
D0=correction factor for converting a luminance correction factor variation into a drive adjustment value variation (D0>0), and
x0=target value of R or B color component value,
D1=conversion factor for converting a color component value variation into a drive adjustment value variation (D1>0), and
Dm=median drive adjustment value.

As described above, in a state in which the reference signal for the first video signal is outputted to the TV 100, the PC 40 together with the color analyzer 30 detects the color component amounts of the image displayed on the display screen of the TV 100 and obtains the corresponding first color component values x, y and z, and Y.

Subsequently, the setting of the signal switching section 23 is manually switched to the component side causing the reference component video signal to be outputted to the signal generation circuit 40. In this state, the TV 100 inputs the reference component video signal via the component video input terminals 182 to 184 (S130). As an alternative method, a signal to set the signal switching section 23 to the component side may be outputted from the PC 40 to the signal switching section 23 via the I/O port 41g. The TV 100 adjusts the color difference signals R-Y and B-Y and the color signals R, G and B by the amounts dependent on the default component adjustment values, and displays an adjustment image on the display screen. Next, the LOW LIGHT adjusting probe 30a and the HIGH LIGHT adjusting probe 30b are manually brought into contact with the display screen of the TV 100. In this state, the color analyzer 30 detects the color component amounts on both the dark screen 191 and the bright screen 192, and outputs color component values corresponding to the detected color component amounts to the PC 40 (S135). The color component values may comprise, for example, values corresponding to the xy chromaticity and luminance values.

The PC 40 determines whether the reference component video signal is outputted from the signal generation circuit 40. When the PC 40 determines that the reference component video signal is outputted from the signal generation circuit 40, the PC 40 obtains the second color component values x, y, z, and Y (S140) outputted from the color analyzer 30 separately for the dark screen 191 and for the bright screen 192. The same as in S115, when a prescribed key operation is performed from the keyboard 41f1, the PC 40 determines that the reference component video signal is being outputted. Until the prescribed key operation is performed, the processing of S140 is not performed.

Furthermore, the PC 40 compares the differences between the first color component values x, y, z, and Y and the second color component values x, y, z, and Y and the prescribed reference values to determine whether or not the differences between the first and the second color component values are outside a prescribed range (S145). For example, for each of the color component values x, y, z, and Y, whether or not the absolute value of the difference between the first and the second color component values is greater than a prescribed reference value is determined. When the absolute value is greater than the prescribed reference value, the difference between the first and the second color component values is judged to be outside the prescribed range. When the absolute value is not greater than the prescribed reference value, the difference between the first and the second color component values is judged to be inside the prescribed range.

The difference between the first and the second color component values judged to be outside the prescribed range constitutes a case of out-of-specification. In such a case, processing advances to S150. In S150, the five kinds of component adjustment values are calculated based on the second color component values obtained, and the calculated component adjustment values are outputted to the TV 100. The component adjustment values can be calculated in the same manner as for the white balance adjustment values described above. As described above, in a state in which the reference signal for the second video signal is being outputted to the TV 100, the PC 40 together with the color analyzer 30 detects the color component amounts of the image displayed on the display screen of the TV 100 and obtains the corresponding second color component values.

The TV 100 inputs the five kinds of component adjustment values via the IIC bus data port 102 and stores the values in the EEPROM 150 under the control of the microcomputer 110 (S155). Since, at this time, the reference component video signal is continuously inputted to the TV 100, the TV 100 reads out the newly stored component adjustment values from the EEPROM 150, adjusts, in the internal chroma circuit, the color difference signals R-Y and B-Y and the color signals R, G and B by the amounts dependent on the component adjustment values, and displays an image on the display screen.

Subsequently, until the differences between the first and the second color component values obtained are inside the prescribed range, the PC 40 repeats S140 through S150, that is, calculating the component adjustment values based on the second color component values, outputting the calculated component adjustment values, and obtaining the second color component values from the color analyzer 30. When the differences between the first and the second color component values are found to be inside the prescribed range in S145, the PC 40 terminates the processing. When the final component adjustment values are outputted to the TV 100, the differences between the first and the second color component values have been reduced. In this way, the white balance of a component video image can be matched to the white balance of a composite video image.

As described above, the PC 100 performs white balance adjustment by determining the second adjustment values such that the white balance of an image based on the second video signal is matched to the white balance of an image based on the first video signal and outputting the second adjustment values thus determined to the TV 100. The above processing performed by the PC 100 and the color analyzer 30 make up an adjusting means meant in the present invention.

As described above, the present invention enables sufficiently adjusting the white balance of not only an image based on the composite video signal but also an image based on the component video signal. It is therefore possible to display an image whose white balance has been well adjusted whether in composite mode or in component mode. Hence the present invention can provide a TV to which both the composite and the component video signals are inputted and in which the difference in white balance observed between an image based on the composite video signal and an image based on the component video signal is reduced. With different adjustment values prepared for different TVs, both the white balance of an image based on the composite video signal and the white balance of an image based on the component video signal can be adjusted separately for each TV. Therefore, in a TV to which both the composite and the component video signals are inputted, the difference in white balance observed between a composite video image and a component video image can be reliably reduced. When white balance adjustment is performed, the component adjustment values are automatically set without requiring such troublesome work as adjusting resistance values of resistor circuits in the TV to be performed. As a result, the burden of white balance adjustment work at a TV manufacturing plant is reduced and productivity at the TV manufacturing plant can be increased.

(6) Operation of Television

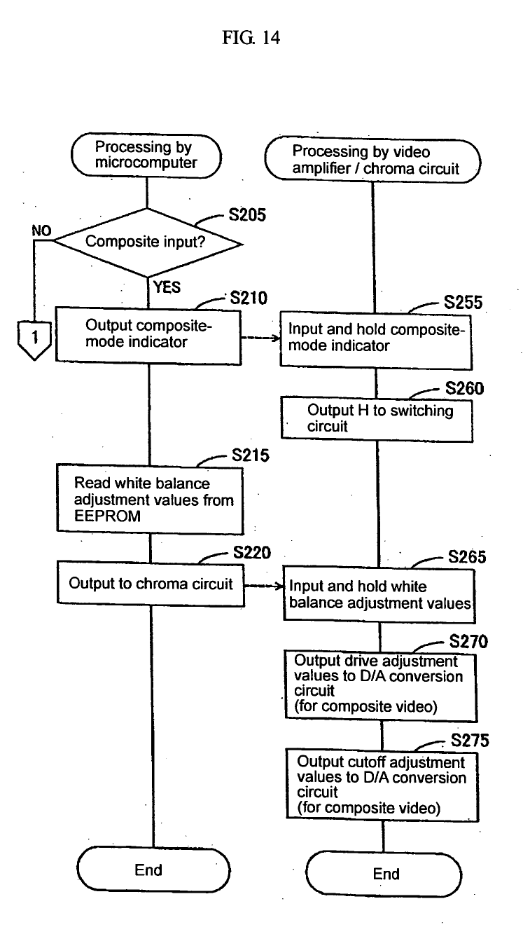

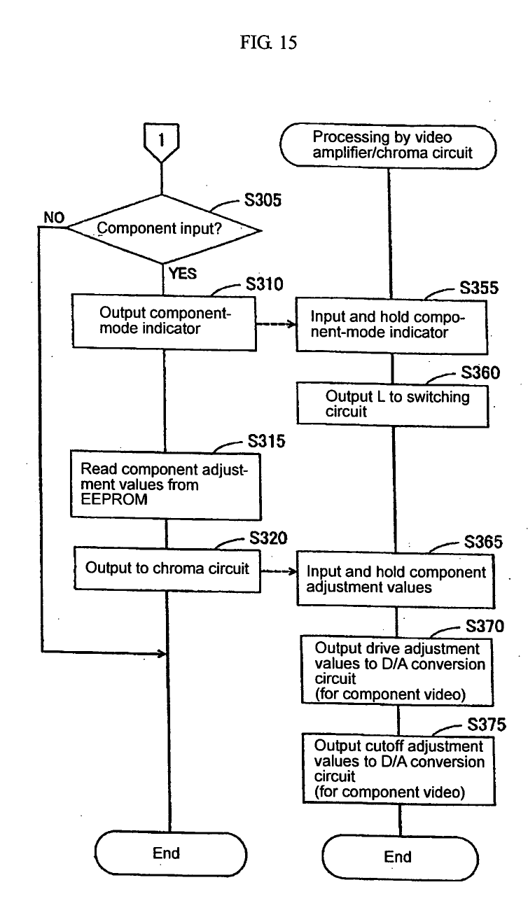

FIGS. 14 and 15 are flowcharts showing the adjustment processing performed in the TV 100 by the microcomputer 110 and the control circuit 131 included in the video amplifier/chroma circuit 130. The processing shown in the flowcharts is executed repeatedly according to the program stored in the ROM 112. First, the microcomputer 110 determines whether or not to input the composite video signal (S205). In the present embodiment, inputting of the composite video signal is determined when a prescribed key operation is performed from the operation panel 119 or from a remote control transmitter, not shown. When it is determined not to input the composite video signal, processing advances to S305.

When it is determined to input the composite video signal, the microcomputer 110 outputs a composite-mode indicator (a prescribed code, for example) to the chroma circuit (S210). The control circuit 131 included in the chroma circuit inputs the composite-mode indicator and stores the indicator in the internal memory 131b (S255). Next, the control circuit 131 outputs a voltage level H to the switching circuits SW1 to SW3 via the I/O port 131c (S260). Each of the switching circuits SW1 to SW3 to which the voltage level H has been inputted switches its input section shown in FIG. 5 to the composite side (upper side in FIG. 5), thereby inputting a video signal separated from the composite video signal and outputs the inputted video signal from the output section.

Subsequently, the microcomputer 110 reads out digital white balance adjustment values from the EEPROM 150 (S215). As shown in FIG. 7, the white balance adjustment values comprise cutoff adjustment values for color signals R, G and B which enable cutoff adjustment for color signals R, G and B based on the composite video signal and drive adjustment values for color difference signals R-Y and B-Y which enable drive adjustment for color difference signals R-Y and B-Y based on the composite video signal. The microcomputer 110 outputs the white balance adjustment values it read out to the chroma circuit and terminates the processing (S220).

The control circuit 131 included in the chroma circuit inputs the above white balance adjustment values and stores them in the internal memory 131b (S265). Next, the control circuit 131 outputs the two kinds of drive adjustment values to the D/A conversion circuit 145 (S270). The D/A conversion circuit 145 converts the digital drive adjustment values into the corresponding analog voltages and outputs the analog voltages to the drive adjustment circuit 142. The drive adjustment circuit 142 adjusts the drive for each of the color difference signals R-Y and B-Y according to the output voltages of the D/A conversion circuit 145 and outputs the color difference signals R-Y and B-Y to the matrix circuit 143. In this way, the color difference signals R-Y and B-Y outputted from the demodulator circuit 141 are subjected to drive adjustment with the adjustment amounts being dependent on the drive adjustment values.

Furthermore, the control circuit 131 outputs the three kinds of cutoff adjustment values to the D/A conversion circuit 146 (S275) and terminates the processing. The D/A conversion circuit 146 converts the digital cutoff adjustment values into the corresponding analog voltages and outputs the voltages to the cutoff adjustment circuit 144. The cutoff adjustment circuit 144 performs cutoff adjustment for each of the color signals R, G and B according to the output voltages of the D/A conversion circuit 146 and outputs the adjusted color signals to the external video output circuit 161. In this way, the color signals R, G and B outputted from the matrix circuit 143 are subjected to cutoff adjustment with the adjustment amounts being dependent on the cutoff adjustment values.

As described above, the TV 100 outputs the white balance adjustment values stored in the EEPROM 150 to the chroma circuit and, in the chroma circuit, adjusts the combination of the color difference signals R-Y and B-Y and the color signals R, G and B by the amounts dependent on the white balance adjustment values. Finally, the TV 100 displays an image whose white balance has been adjusted according to the white balance adjustment values for a composite video image.

In S305 shown in FIG. 15, the microcomputer 110 determines whether or not to input the component video signal. Like in the S205 described above, inputting of the component video signal is determined when a prescribed key operation is performed from a device such as the operation panel 119. When it is determined not to input the component video signal, processing is terminated.

When it is determined to input the component video signal, the microcomputer 110 outputs a component-mode indicator (a prescribed code, for example) to the chroma circuit (S310). The control circuit 131 included in the chroma circuit inputs the component-mode indicator and stores the indicator in the internal memory 131b (S355). Next, the control circuit 131 outputs a voltage level L to the switching circuits SW1 to SW3 via the I/O port 131c (S360). Each of the switching circuits SW1 to SW3 to which the voltage level L has been inputted switches the corresponding input section shown in FIG. 5 to the component side (lower side in FIG. 5), thereby inputting component video signals [Y], [V] and [U] and outputs the video signals from the output section.

Subsequently, the microcomputer 110 reads out digital component adjustment values from the EEPROM 150 (S315). As shown in FIG. 7, the component adjustment values comprise cutoff adjustment values for color signals R, G and B which enable cutoff adjustment for the color signals R, G and B based on the component video signal and drive adjustment values for color difference signals R-Y and B-Y which enable drive adjustment for the color difference signals R-Y and B-Y based on the component video signal. The microcomputer 110 outputs the component adjustment values it read out to the chroma circuit and terminates the processing (S320).

The control circuit 131 included in the chroma circuit inputs the above component adjustment values and stores them in the internal memory 131b (S365). Next, the control circuit 131 outputs the two kinds of drive adjustment values to the D/A conversion circuit 145 (S370). The D/A conversion circuit 145 converts the digital drive adjustment values into the corresponding analog voltages and outputs the analog voltages to the drive adjustment circuit 142. The drive adjustment circuit 142 adjusts the drive for each of the color difference signals R-Y and B-Y according to the output voltages of the D/A conversion circuit 145 and then outputs the color difference signals R-Y and B-Y to the matrix circuit 143. In this way, the color difference signals R-Y and B-Y outputted from the demodulator circuit 141 are subjected to drive adjustment with the adjustment amounts being dependent on the drive adjustment values.

Furthermore, the control circuit 131 outputs the three kinds of cutoff adjustment values to the D/A conversion circuit 146 (S375) and terminates the processing. The D/A conversion circuit 146 converts the digital cutoff adjustment values into the corresponding analog voltages and outputs the voltages to the cutoff adjustment circuit 144. The cutoff adjustment circuit 144 performs cutoff adjustment for each of the color signals R, G and B according to the output voltages of the D/A conversion circuit 146 and outputs the adjusted color signals to the external video output circuit 161. In this way, in component mode, too, the color signals R, G and B outputted from the matrix circuit 143 are subjected to cutoff adjustment with the adjustment amounts being dependent on the cutoff adjustment values.

As described above, the TV 100 outputs the component adjustment values stored in the EEPROM 150 to the chroma circuit and, in the chroma circuit, adjusts the combination of the color difference signals R-Y and B-Y and the color signals R, G and B by the amounts dependent on the component adjustment values. Finally, the TV 100 displays an image whose white balance has been adjusted according to the component adjustment values for a component video image.

As described above, the TV of the present invention enables sufficiently adjusting the white balance of not only an image based on the composite video signal but also an image based on the component video signal. With different adjustment values prepared for different TVs, both the white balance of an image based on the composite video signal and the white balance of an image based on the component video signal can be adjusted separately for each TV. Therefore, in a TV to which both the composite and the component video signals are inputted, the difference in white balance observed between a composite video image and a component video image can be reliably reduced.

The present invention can also be applied to a TV which displays an image by selectively inputting plural video signals which represent brightness and color with plural kinds of signals. The TVs to which the present invention can be applied include, for example, a TV in which the component video signal is used as the first video signal and the composite video signal is used as the second video signal, a TV in which an RF signal inputted from an RF signal input section is used as the first video signal and a TV in which the composite video signal is used as the first image signal and a composite RF signal and the component video signal are used as the second video signal. The white balance adjustment values and the component adjustment values are only required to be values to adjust the white balance of an image based on the composite video signal and the white balance of an image based on the component video signal, respectively. Therefore, they may comprise other kinds of values than the foregoing five kinds of values and, needless to say, they need not necessarily include all of the foregoing five kinds of values.

As described above, according to the present invention, when plural kinds of video signals are selectively inputted to a television in various modes the difference in white balance observed between images based on the plural kinds of video signals can be reduced.

The foregoing invention has been described in terms of preferred embodiments. However, those skilled, in the art will recognize that many variations of such embodiments exist. Such variations are intended to be within the scope of the present invention and the appended claims.

1. A television adjustment system comprising;
a television which selectively inputs a composite video signal combining a luminance signal and color difference signals or a component video signal comprising a discrete luminance signal and discrete color difference signals, generates three primary color signals from the inputted luminance signal and the inputted color difference signals in an internal chroma circuit, and
displays an image based on the generated three primary color signals, and which can
input white balance adjustment values prepared for each the television to adjust the white balance of an image based on the composite video signal,
store the white balance adjustment values in an EEPROM, output the stored white balance adjustment values to the chroma circuit,
adjust in the chroma circuit either or a combination of the color difference signals and the three primary color signals by amounts dependent on the stored white balance adjustment values, and display an image which has been subjected to white balance adjustment intended for an image based on the composite video signal,
a signal generation circuit which generates a reference composite video signal for determining the white balance adjustment values and outputs the reference composite video signal to the television,
a color analyzer which can detect color component amounts of an image displayed by the television and output corresponding color component values, and
a computer for white balance adjustment which outputs the white balance adjustment values and thereby adjusts the white balance of the image displayed by the television, the improvement wherein:
the television can input component adjustment values prepared for each the television to adjust the white balance of an image based on the component video signal and store the component adjustment values in the EEPROM;
when the component video signal is inputted, the television outputs the stored component adjustment values to the chroma circuit, thereby adjusts in the chroma circuit either or a combination of the color difference signals and the three primary color signals by amounts dependent on the stored component adjustment values, and displays an image which has been subjected to white balance adjustment intended for an image based on the component video signal;
the signal generation circuit generates and outputs a reference component video signal for determining the component adjustment values;
the computer for white balance adjustment, in a state in which the reference composite video signal is being outputted from the signal generation circuit, obtains first color component values outputted from the color analyzer, determines the white balance adjustment values based on the first color component values and outputs the white balance adjustment values to the television; and
the computer for white balance adjustment, in a state in which the reference component video signal is being outputted, obtains second color component values outputted from the color analyzer, and
matches the white balance of an image based on the component video signal to the white balance of an image based on the composite video signal by repeating a process of calculating the component adjustment values based on the second color component values, outputting the calculated component adjustment values, and obtaining the second color component values from the color analyzer until differences between the first and the second color component values obtained are inside a prescribed range.

2. A television adjustment system comprising;
a television which can selectively input a first or a second video signal which represents brightness and color with plural kinds of signals and, when displaying an image based on the inputted video signal, can display an image which has been subjected to white balance adjustment intended for an image based on the first video signal, amounts of the white balance adjustment being dependent on adjustment values stored in a nonvolatile memory for use in adjusting the white balance of an image based on the first video signal, and
adjusting means to adjust the white balance of an image for the television, wherein:
the television can input second adjustment values for adjusting the white balance of an image based on the second video signal and store the inputted second adjustment values in the nonvolatile memory and, when the second video signal is inputted and an image based on the second video signal is to be displayed, can display an image which has been subjected to white balance adjustment intended for the second video signal, amounts of the white balance adjustment being dependent on the second adjustment values stored in the nonvolatile memory;
the adjusting means, in a state in which a reference signal for the first video signal is being outputted to the television, detects color component amounts of an image displayed by the television and obtains corresponding first color component values; and
the adjusting means, in a state in which a reference signal for the second video signal is being outputted to the television, detects color component amounts of an image displayed by the television, obtains corresponding second color component values, determines the second adjustment values based on the first and the second color component values thus obtained such that the white balance of an image based on the second video signal matches the white balance of an image based on the first video signal, outputs the second adjustment values to the television, and thereby effects the white balance adjustment.

3. A television which can selectively input a first or a second video signal which represents brightness and color with plural kinds of signals and, when displaying an image based on the inputted video signal, can display an image which has been subjected to white balance adjustment intended for an image based on the first video signal, amounts of the white balance adjustment being dependent on adjustment values stored in a nonvolatile memory for use in adjusting the white balance of an image based on the first video signal, wherein;
the nonvolatile memory stores second adjustment values for adjusting the white balance of an image based on the second video signal and,
when the second video signal is inputted and an image based on the second video signal is to be displayed, an image which has been subjected to white balance adjustment intended for an image based on the second video signal is displayed, amounts of the white balance adjustment being dependent on the second adjustment values stored in the nonvolatile memory.

4. The television according to claim 3, wherein one of the first and the second video signals is a composite video signal combining a luminance signal and color difference signals, and the other of the first and the second video signals is a component video signal comprised of a discrete luminance signal and discrete color difference signals.

5. The television according to claim 4 wherein;
the television generates three primary color signals from the luminance signal and the color difference signals and displays an image based on the three primary color signals,
the second adjustment values include cutoff adjustment values representing cutoff adjustment amounts at least for the three primary color signals, and
the television adjusts each of the three primary color signals by amounts dependent on the cutoff adjustment values stored in the nonvolatile memory and displays an image which has been subjected to white balance adjustment intended for the second video signal.

6. The television according to claim 5 wherein;
the second adjustment values include drive adjustment values representing drive adjustment amounts at least for the color difference signals, and
the television adjusts the color difference signals by amounts dependent on the drive adjustment values stored in the nonvolatile memory and displays an image which has been subjected to white balance adjustment intended for the second video signal.

7. The television according to claim 6 wherein;
the nonvolatile memory allows data stored therein to be rewritten, and
the adjustment values and the second adjustment values can be inputted and stored in the nonvolatile memory.

8. The television according to claim 7 wherein the nonvolatile memory is an EEPROM and the second adjustment values are prepared for each the television and stored in the EEPROM.

9. A television which selectively inputs a composite video signal combining a luminance signal and color difference signals or a component video signal comprising a discrete luminance signal and discrete color difference signals, generates three primary color signals from the inputted luminance signal and the inputted color difference signals in an internal chroma circuit, and
displays an image based on the generated three primary color signals,
wherein,
the television can input white balance adjustment values prepared for each the television to adjust the white balance of an image based on the composite video signal,
store the white balance adjustment values in an EEPROM, output the stored white balance adjustment values to the chroma circuit,
adjust in the chroma circuit either or a combination of the color difference signals and the three primary color signals by amounts dependent on the stored white balance adjustment values, and display an image which has been subjected to white balance adjustment intended for an image based on the composite video signal, the improvement, and,
wherein,
the television can input component adjustment values prepared for each the television to adjust the white balance of an image based on the component video signal and store the component adjustment values in the EEPROM, and
when the component video signal is inputted, the television outputs the stored component adjustment values to the chroma circuit, adjusts in the chroma circuit either or a combination of the color difference signals and the three primary color signals by amounts dependent on the stored component adjustment values, and displays an image which has been subjected to white balance adjustment intended for an image based on the component video signal.

10. A computer for white balance adjustment to adjust the white balance of an image for a television which can selectively input a first or a second video signal which represents brightness and color with plural kinds of signals and, when displaying an image based on the inputted video signal, can display an image which has been subjected to white balance adjustment intended for an image based on the first video signal, amounts of the white balance adjustment being dependent on adjustment values stored in a nonvolatile memory for use in adjusting the white balance of an image based on the first video signal;
wherein, in a state in which a reference signal for the first video signal is being outputted to the television, first color component values are obtained from color analyzing means which can detect color component amounts of an image displayed by the television and output corresponding color component values, wherein, in a state in which a reference signal for the second video signal is being outputted to the television, second color component values are obtained from the color analyzing means; and
wherein the second adjustment values are determined based on the first and the second color component values thus obtained such that the white balance of an image based on the second video signal matches the white balance of an image based on the first video signal and are outputted to the television to thereby effect the white balance adjustment.
